(19) United States
(12) Patent Application Publication
(10) Pub. No.: US 2021/0059126 A1
(43) Pub. Date: Mar. 4, 2021

(54) PLANT WALL

(71) Applicants: Christopher Lee Curtis, Waterdown (CA); Lee Malcom Curtis, Oakville (CA)

(72) Inventors: Christopher Lee Curtis, Waterdown (CA); Lee Malcom Curtis, Oakville (CA)

(21) Appl. No.: 16/558,929

(22) Filed: Sep. 3, 2019

(51) Int. Cl. A01G 9/02; A01G 27/00

(52) U.S. Cl. CPC A01G 9/025; A01G 9/023; A01G 27/005

(57) ABSTRACT

The present application relates generally to plants, and specifically to a plant wall including a frame that is configured to secure to a surface and at least one panel that is configured to secure to the frame. The plant wall also includes at least one planter configured to secure to the at least one panel and at least one emitter positioned on the at least one planter, defining a passage therethrough. The plant wall further includes a pressure barrel that is filled with water. The water is transported from the pressure barrel through at least one hose, which contains at least one connector that connects to the at least one emitter between a first end and a second end of the hose, and into the at least one planter, which contains a plant and soil. A related method of watering a plant using a pressure barrel is also described.

### FIELD OF THE INVENTION

The present specification relates generally to plants, and specifically to an apparatus and method for watering an indoor plant wall.

### BACKGROUND OF THE INVENTION

Indoor plants or houseplants, as they are also called, are often used for interior décor owing to their aesthetically pleasing appearance, and ability to improve indoor air quality and promote psychological well-being. While indoor plants are traditionally housed in pots, planters, and other containers that are suitably sized to hold plants grown in soil or other media, indoor plants may also be grown vertically on a wall, for example, where horizontal space is limited.

Plant walls, also referred to as green walls, living walls, or vertical gardens, are either partially or completely covered with greenery, and include a growing medium, such as soil, water or another substrate, and often also include an integrated water delivery system. Where no water delivery system is used, plant walls depend on manual watering through the use of a watering can, for example. While integrated water delivery systems eliminate the need for manual watering, plant walls equipped with these systems require pumps, drainage, electrical and water supply. This equipment often requires additional space to house these various elements making plant walls incompatible with smaller spaces and onerous to install. Some plant walls house these elements behind the plant façade, in which case the plant wall may extend away from or into the wall to provide the required storage space. Some plant walls depend on a neighboring pump room. In either case, these plant walls are complex to install and require substantial, ongoing maintenance.

A further challenge associated with some known plant wall water delivery systems is that water delivery is inefficient and not uniform. The method of watering plant walls typically involves the diffuse delivery of water at a point or points at the top of the wall and reliance on gravity to draw the water down the length of the wall. This method of irrigation requires additional water to compensate for the diffuse nature of the delivery and ensure adequate supply to all plants.

Accordingly, there is a need for improvements in the art to eliminate the need for power, pumps, drainage, and hard water lines required for operation of a plant wall and to reduce the amount of water needed to adequately supply each plant.

### SUMMARY OF THE INVENTION

According to an embodiment of the present invention, there is a plant wall, comprising: a frame; at least one panel, whereby the at least one panel is configured to secure to the frame and whereby the frame is configured to secure to a surface; at least one planter, wherein the at least one planter is configured to secure to the at least one panel and the at least one planter is hollowed providing a means for containing a plant and soil; at least one emitter, whereby the at least one emitter is positioned on the at least one planter and the at least one emitter defines a passage therethrough; at least one hose, wherein the at least one hose has a first hose end, a second hose end, wherein the second hose end contains an impermeable end cap, and at least one connector to the at least one emitter positioned between the first hose end and the second hose end; and a pressure barrel, wherein the pressure barrel is filled with water, and whereby the first hose end is configured to fasten to the pressure barrel and the at least one connector is secured to the at least one emitter, allowing for transportation of water from the pressure barrel through the at least one hose, through the passage defined by the at least one emitter, and into the at least one planter.

According to a further embodiment, the present invention provides a method of watering a plant, comprising: fastening a pressure barrel, wherein the pressure barrel is filled with water, to a first end of a hose, wherein the hose further contains a second end with an impermeable end cap and at least one connector positioned between the first end of the hose and the second end of the hose; and releasing the water contained in the pressure barrel, whereby the water flows through the hose to at least one emitter positioned on at least one planter, wherein the planter contains a plant and soil, and whereby the at least one emitter is secured to the at least one connector thereby allowing the water to flow therethrough.

Other aspects and features according to the present application will become apparent to those ordinarily skilled in the art upon review of the following description of embodiments of the invention in conjunction with the accompanying figures.

### BRIEF DESCRIPTION OF THE DRAWINGS

The principles of the invention may better be understood with reference to the accompanying figures provided by way of illustration of an exemplary embodiment, or embodiments, incorporating principles and aspects of the present invention, and in which:

FIG. 1 is an environmental view of a plant wall installed in an office environment, according to an embodiment;

FIG. 2 is a right side perspective view of a plant wall frame with a plurality of panels and planters, according to an embodiment;

FIG. 3 is a front view of a plant wall frame with a plurality of panels, according to an embodiment;

FIG. 4 is a right side view of the frame of FIG. 3;

FIG. 5 is a is a front view of a single plant wall panel, according to an embodiment;

FIG. 6 is a left side view of the panel of FIG. 5;

FIG. 6a is an enlarged view of the panel of FIG. 6;

FIG. 7 is a right side view of a French cleat mounting system, according to an embodiment;

FIG. 8 is a bottom, right side perspective view of a plant wall planter, according to an embodiment;

FIG. 9 is a is a front view of the planter of FIG. 8;

FIG. 10 is a top view of the planter of FIG. 8;

FIG. 11 is a side, sectional view of the planter taken along line 11-11 of FIG. 10;

FIG. 12 is a right side, perspective view of a plant wall planter secured to a plant wall panel, according to an embodiment;

FIG. 13 is a top plan view of a plant wall emitter positioned on the plant wall planter of FIG. 12;

FIG. 14 is a right side, perspective view of a plurality of planters secured to a plant wall panel, according to an embodiment;

FIG. 15 is a front view of a plurality of planters secured to a plant wall panel, according to an embodiment;

FIG. 16 is a perspective view of a portion of a plant wall hose, according to an embodiment;

FIG. 17 is a perspective view of a portion of a plant wall hose, according to an embodiment; and

FIG. 18 is a front perspective view of a pressure barrel, according to an embodiment.

### DETAILED DESCRIPTION OF EMBODIMENTS OF THE INVENTION

The description that follows, and the embodiments described therein, are provided by way of illustration of an example, or examples, of particular embodiments of the principles of the present invention. These examples are provided for the purposes of explanation, and not of limitation, of those principles and of the invention. In the description, like parts are marked throughout the specification and the drawings with the same respective reference numerals. The drawings are not necessarily to scale and, in some instances, proportions may have been exaggerated in order to more clearly depict certain features of the invention.

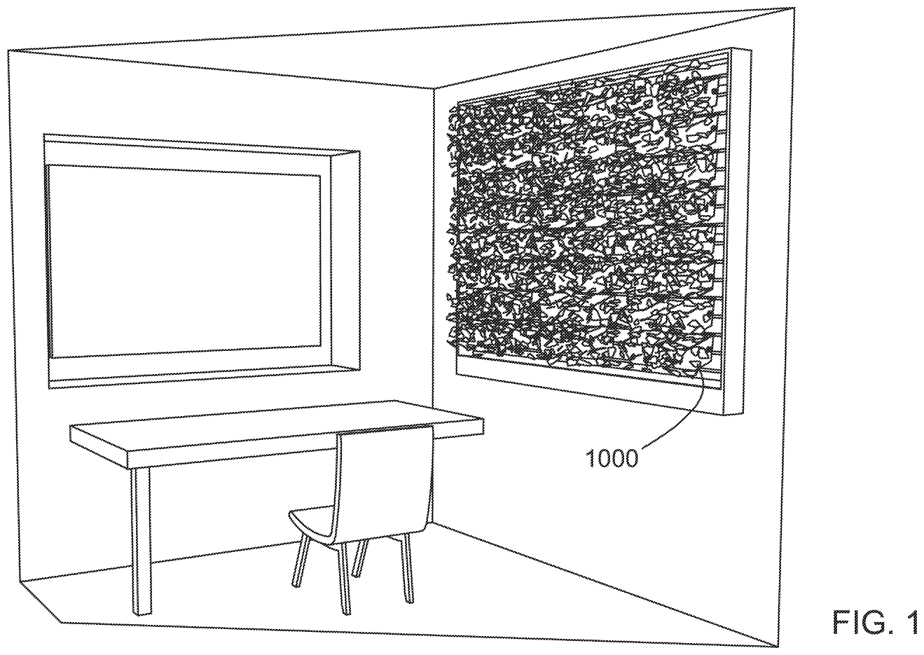

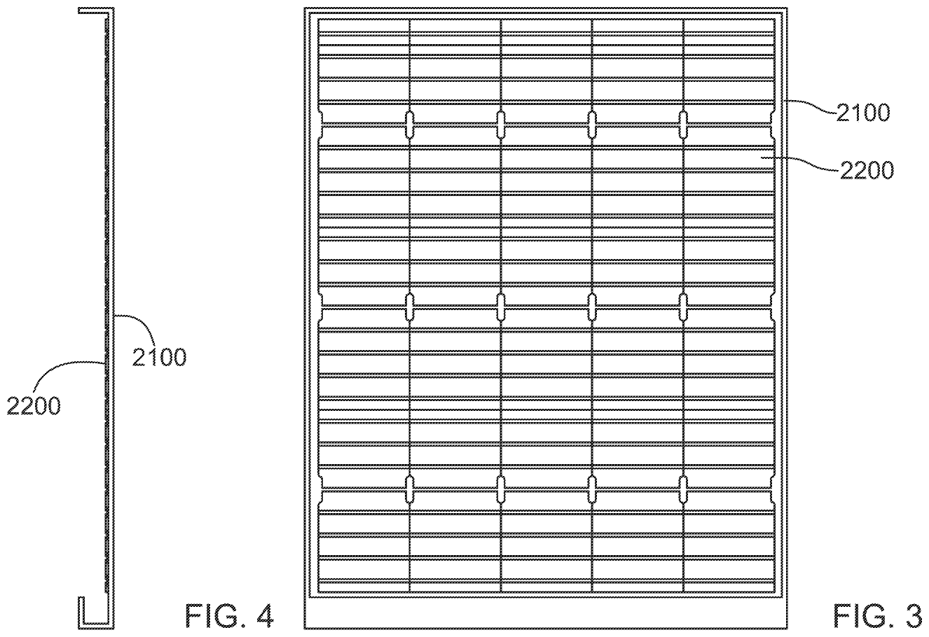

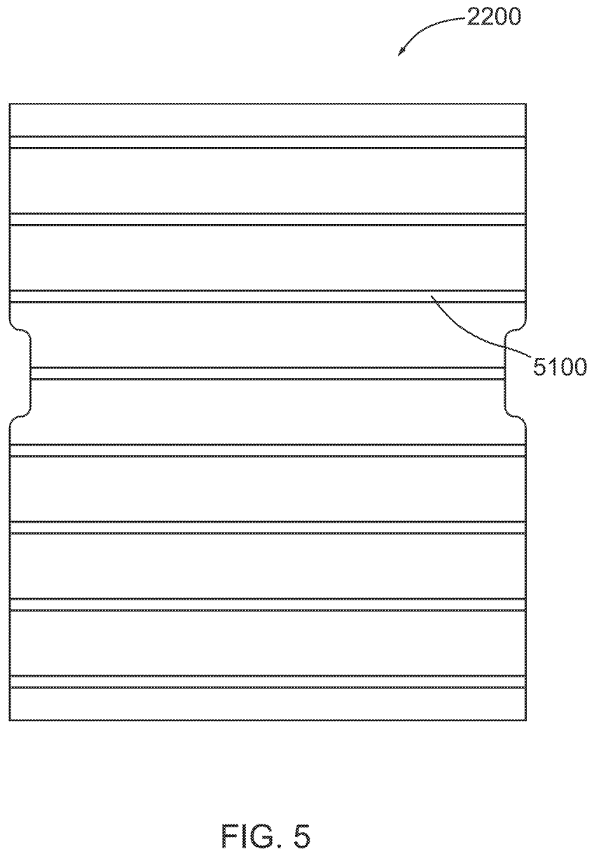

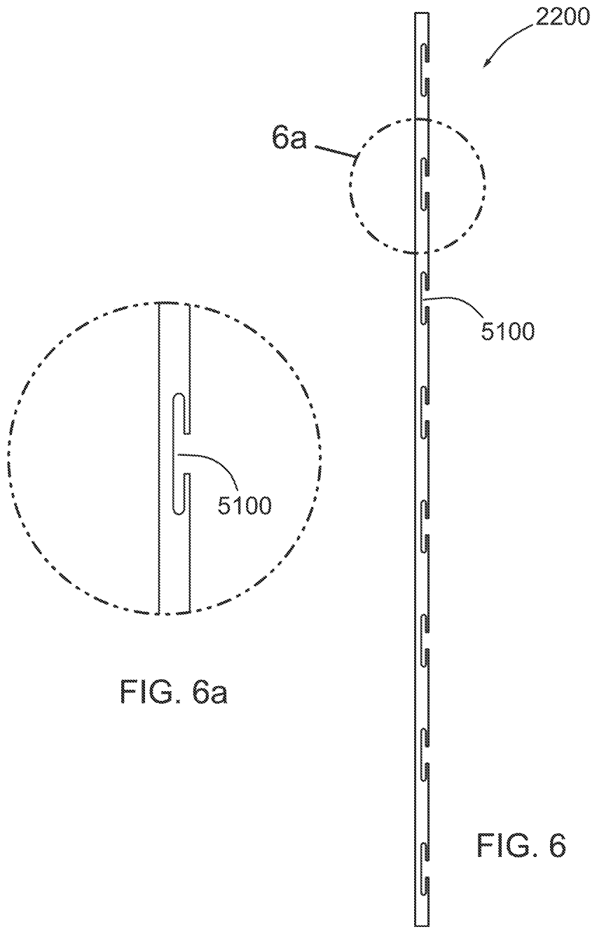

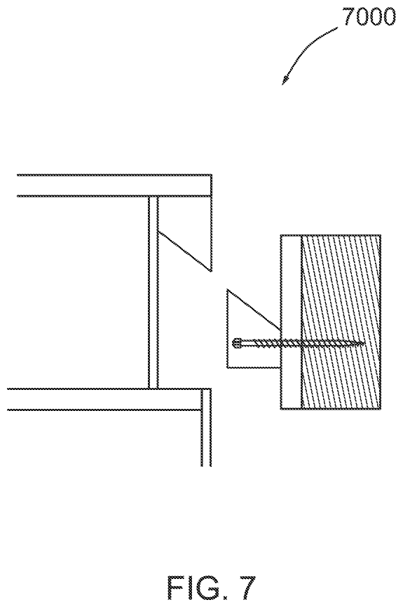

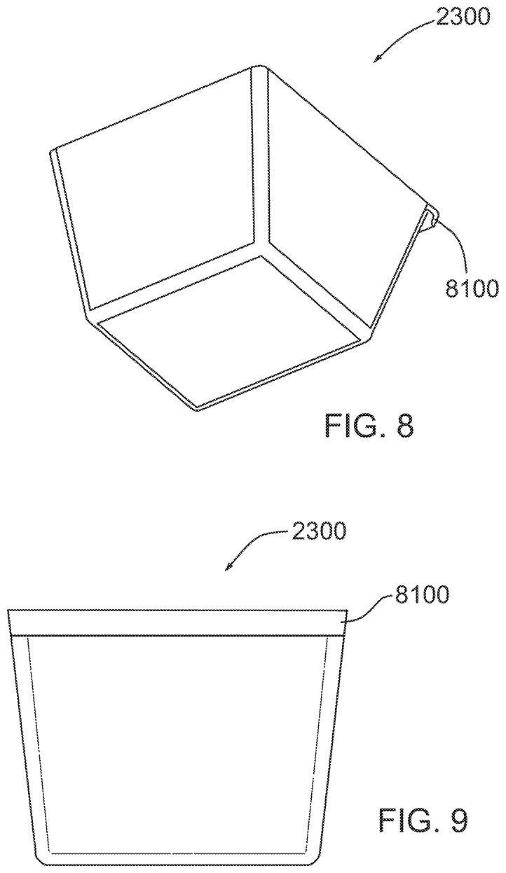

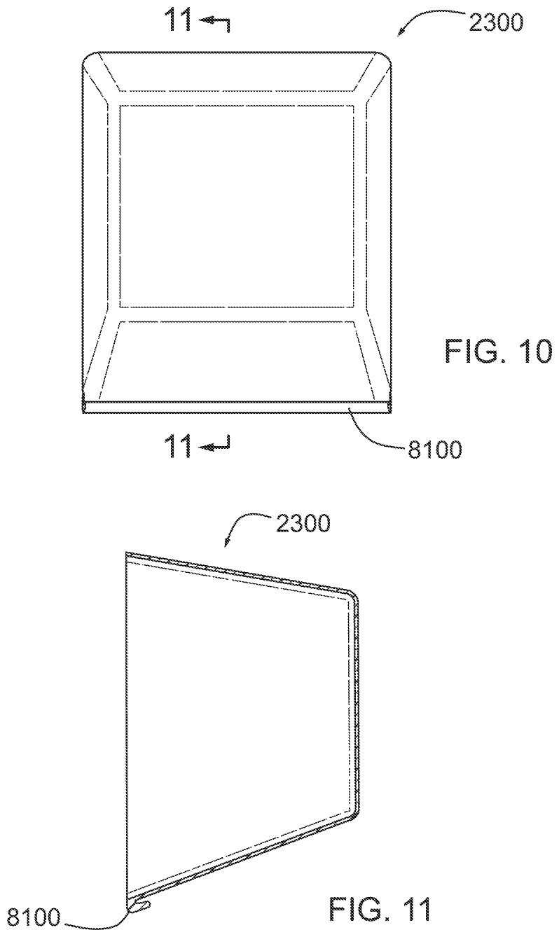

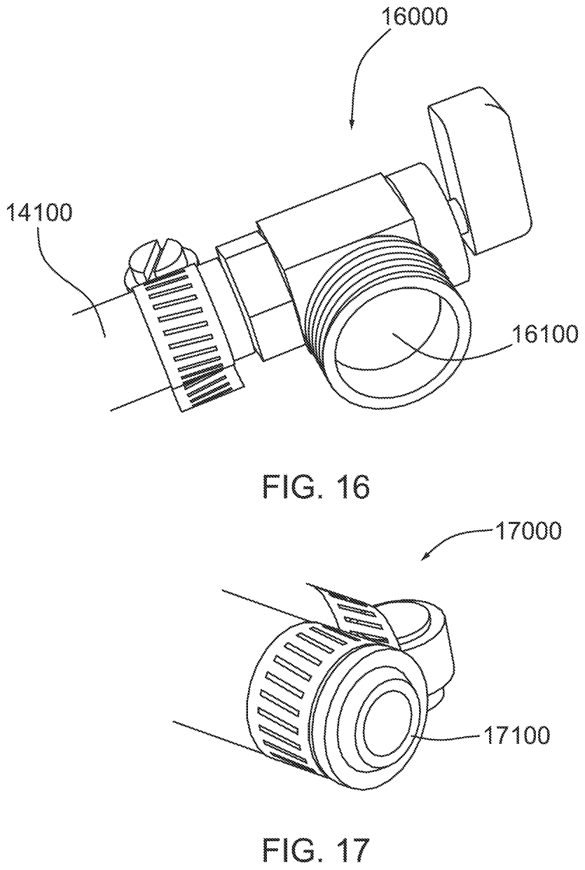

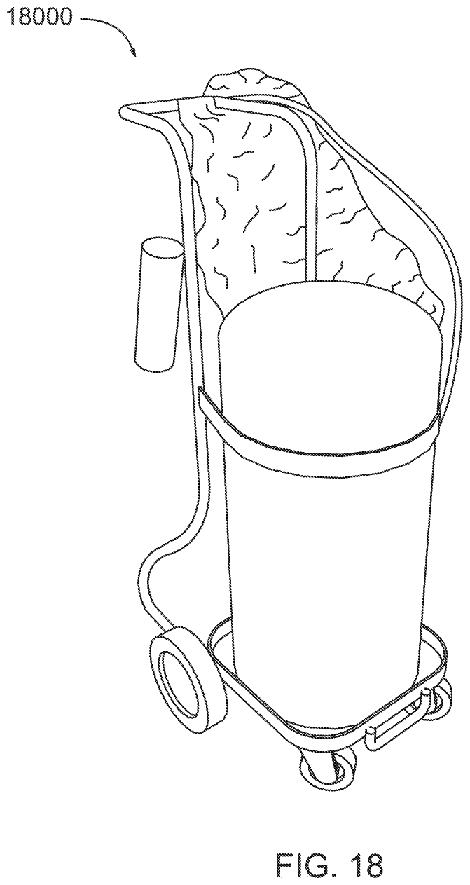

According to embodiments shown in FIGS. 1 to 18, a plant wall 1000 is generally configured to support growing plants and other vegetation without utilizing power, pumps, and hardwired drainage and water lines. This equipment often requires additional space to house these various elements, making plant walls incompatible with smaller spaces and onerous to install. Plant wall 1000, because it does not require this equipment, may be easily installed and does not require additional storage space, aside from room to place plant wall 1000 façade itself. Therefore, plant wall 1000 may be a more viable décor option in a variety of environments. Further, in addition to providing the known health and environmental benefits of increased vegetation, plant wall 1000 may also provide aesthetic appeal to, for example, an office, waiting room, or building atrium, by facilitating the growing of plants in a non-traditional manner, namely, on a vertical or substantially vertical surface, such as a wall. While it is preferable to place plant wall 1000 in an indoor environment to avoid exposure to the elements, it may also be desirable to utilize plant wall 1000 outdoors, for example, on the outside of a building. Further, while plant wall 1000 is preferably built on a vertical, or substantially vertical surface, plant wall 1000 may also be designed to accommodate a horizontal, or substantially horizontal surface, akin to more traditional methods of growing plants.

Plant wall 1000 may be constructed from materials which provide the rigidity, strength and durability to support the growing of plants and vegetation on a vertical or substantially vertical surface. According to an embodiment, plant wall 1000 may be constructed of wood, aluminum, steel, plastics or composites or a combination of suitable materials. Manufacturing costs, desired lifespan, and reusability may be considerations in informing the choice of materials and construction technique and other design choices of plant wall 1000.

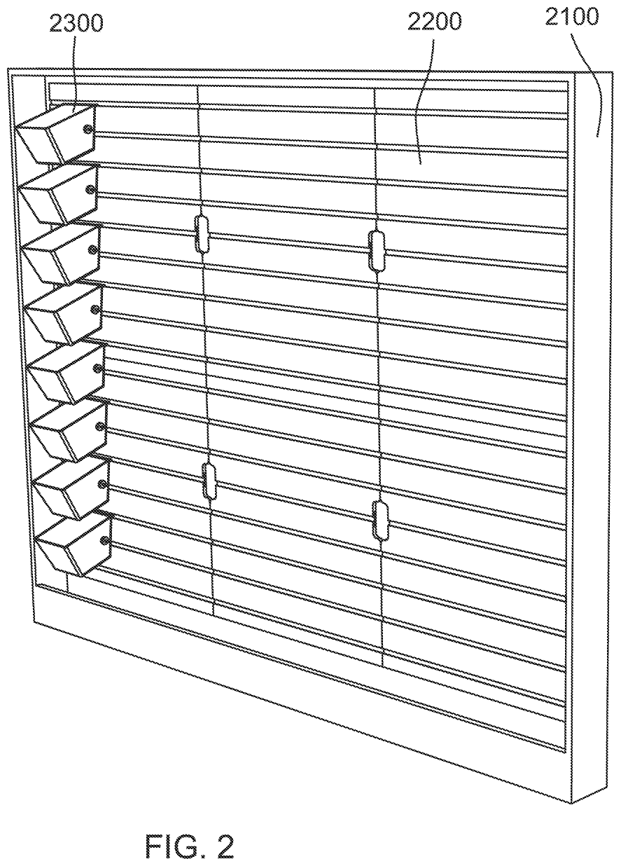

According to embodiments shown in FIGS. 2 to 4, plant wall 1000 includes a frame 2100. Frame 2100, like plant wall 1000, may be constructed from a variety of materials that are suitable for providing rigidity, strength and durability. According to an embodiment, frame 2100 may be composed of any of a number of types of wood, such as cherry or oak, as wood is relatively lightweight, yet sturdy. Further, a particular type of wood may be used based on aesthetic preference. Dimensions of frame 2100 may also be customized to suit aesthetic preference and space requirements, such as specific height and width allowances of a given area. In a preferred embodiment, frame 2100 is relatively compact and measures between 4.5 and 6.5 inches deep. Frame 2100 is configured to secure to a surface, preferably, a vertical or substantially vertical surface, such as a wall. According to an embodiment, the back face of frame 2100 may be secured to a surface using any of a number of known securing mechanisms, such as drywall anchors and screws, toggle anchors with bolts, concrete anchors, or mounting brackets.

According to embodiments shown in FIGS. 2 to 7, plant wall 1000 includes at least one panel 2200 and at least one panel 2200 is configured to secure to frame 2100. At least one panel 2200 may be secured to frame 2100 using any of a number of known securing mechanisms, such as nails, screws or adhesive. According to a preferred embodiment, a back face of at least one panel 2200 may be secured to a front face of frame 2100 by a French cleat system 7000. Utilizing French cleat system 7000 to secure at least one panel 2200 to frame 2100 allows for ease of removal, replacement and repair of at least one panel 2200 if, for example, it breaks or malfunctions. According to a further embodiment, a plurality of panels 2200 may be secured to frame 2100 adjacent to one another or, alternatively, in any artistic configuration. For example, a plurality of panels 2200 may be placed immediately adjacent one another to create a lusher appearance or a plurality of panels 2200 may be secured to frame 2100 in a pattern, creating a different aesthetic appeal.

According to embodiments shown in FIGS. 2 and 8 to 15, plant wall 1000 includes at least one planter 2300 and at least one planter 2300 is configured to secure to at least one panel 2200. At least one planter 2300 may be secured to at least one panel 2200 using any of a number of known securing mechanisms, such as nails, screws or adhesive. According to a preferred embodiment, at least one planter 2300 may be secured to a front face of at least one panel 2200 by placing a hooked lip 8100 of at least one planter 2300 into a corrugated surface 5100 on a front face of the at least one panel 2200. Utilizing this securing mechanism allows for ease of removal, replacement and repair of at least one planter 2300 if, for example, it breaks or malfunctions. According to a further embodiment, a plurality of planters 2300 may be secured to at least one panel 2200 adjacent to one another or, alternatively, in any artistic configuration. For example, a plurality of planters 2300 may be placed immediately adjacent one another to create a lusher appearance or a plurality of planters 2300 may be secured to at least one panel 2200 in a pattern, creating a different aesthetic appeal. Planter 2300 may be composed of recycled polyethylene terephthalate and car tires and, according to a further embodiment, planter 2300 may be hollowed providing a means for containing a plant and soil. According to a preferred embodiment, the soil may be comprised of an inorganic material, such as peat moss and perlite medium, and the plant may be of a tropical species. While other growing media, such as organic soils or even water may be used, peat moss and perlite medium provide ideal growing conditions and prevent against festering or the need for an abundance of water, as is the case with hydroponic watering systems. Similarly, other vegetation and plants may be used depending on the environment in which plant wall 1000 is placed; however, tropical plants are best suited for growing indoors.

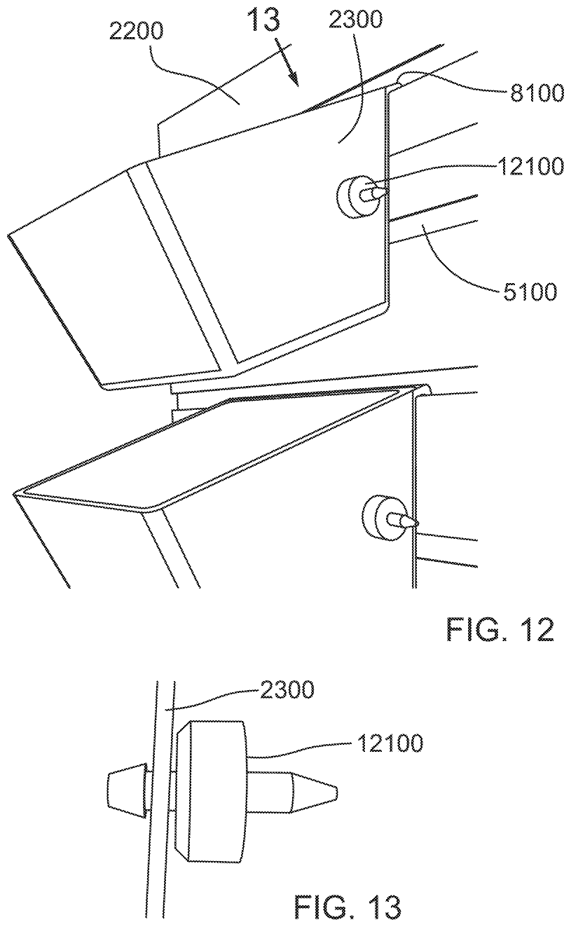

According to embodiments shown in FIGS. 12 to 14, plant wall 1000 further includes at least one emitter 12100 positioned on at least one planter 2300. Emitter 12100 defines a passageway through which water and other nutrients may be delivered into planter 2300 and, subsequently, taken up by the plant or vegetation contained therein. According to a preferred embodiment, emitter 12100 may be positioned proximate to the roots of the plant, typically on the bottom half or the bottom third of the at least one planter 2300. Positioning emitter 12100 proximate to the roots ensures that water and nutrients may be delivered more efficiently than when watering from below or above at least one planter 2300 and may help reduce the amount of water required to water plant wall 1000. According to a further embodiment, a plurality of emitters 12100 may be positioned on an equal number of planters 2300.

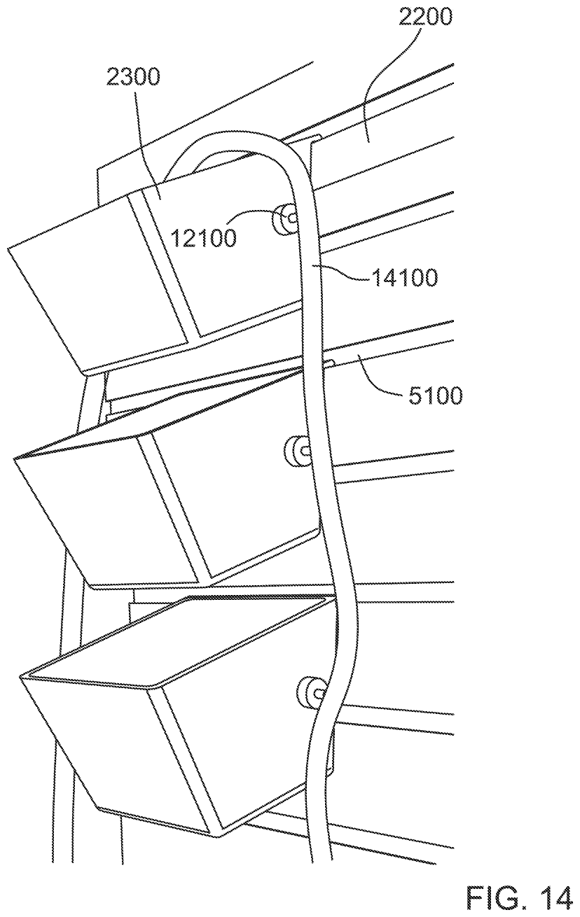

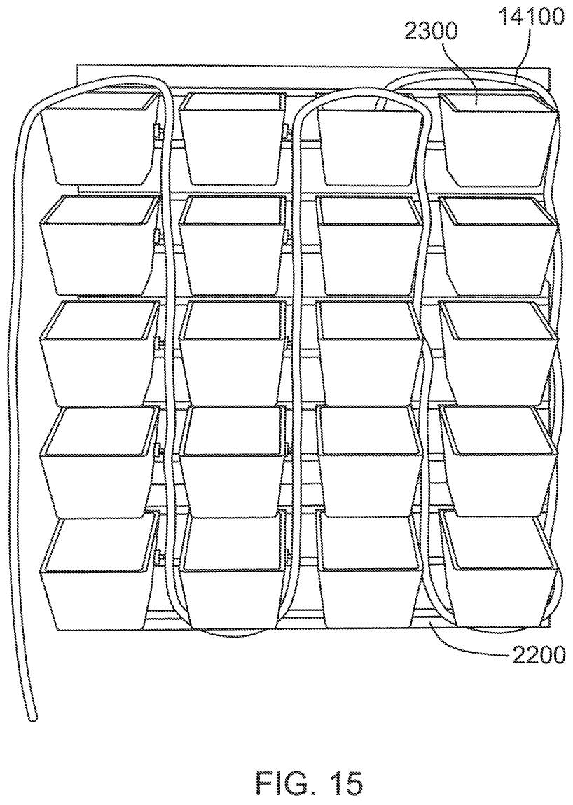

According to embodiments shown in FIGS. 14 to 18, plant wall 1000 further includes at least one hose 14100. At least one hose 14100 may be made of any suitable, flexible tubing material that would allow for the transportation of water therethrough, for example, a rubber, polyvinyl chloride, or vinyl garden hose. Preferably, at least one hose 14100 may be made from corrugated, non-kink material that is commonly also used for outdoor irrigation systems or gas lines. At least one hose 14100 further has a first hose end 16000 and a second hose end 17000. Second hose end 17000 contains an impermeable end cap 17100 and first hose end 16000 is configured to fasten to a pressure barrel 18000, such that both ends of at least one hose 14100 create a watertight seal. According to a further embodiment, a plurality of hoses 14100 may be used, with each of a plurality panels 2300 being connected to a separate hose 14100, as is shown in FIG. 15.

Between first hose end 16000 and second hose end 17000 there is also contained at least one connector to at least one emitter 12100. The at least one connector may be a drip irrigation barbed coupling device, which is inserted into a hole located along the length of the at least one hose 14100. Ideally, the hole is placed at a distance that aligns with and allows for connection to at least one emitter 12100. In a further embodiment, there may be a plurality of connectors that allow for connection to an equal number of emitters 12100. Similarly, a hole on the at least one hose 14100 should be placed at a distance that aligns with and allows for connection to a plurality of emitters 12100.

To facilitate the delivery of water and nutrients from pressure barrel 18000, a female portion 16100 of first hose end 16000 may connect to a male portion of pressure barrel 18000. According to an embodiment, both female portion 16100 and male portion of pressure barrel 18000 may be threaded to enable coupling. According to a further embodiment, pressure barrel 18000 may contain only water, if plants do not require additional nutrients at the time of watering. Further, according to a preferred embodiment, pressure barrel 18000 may be pressurized to five pounds per square inch in order to facilitate the delivery of the contents of pressure barrel 18000, namely, water and nutrients, through at least one hose 14100. Pressure barrel 18000 may also be portable, such that it need only be connected to at least one hose 14100 when plant wall 1000 requires watering.

According to embodiments shown in FIGS. 1 to 18, one may water a plant or plant wall 1000 by fastening pressure barrel 18000, which contains water, to first end of hose 16000. Once fastened, one may release the water contained in pressure barrel 18000, which allows the pressurised water to flow through hose 14100 to at least one emitter 12100, secured to the at least one connector on hose 14100. Water passing through at least one emitter 12100 travels through a passage defined by at least one emitter 12100 and into at least one planter 2300, thereby watering the plant contained therein. Hose 14100 further contains an impermeable end cap 17100 that prevents water from exiting second end of hose 17000 when pressurized water is released from pressure barrel 18000 through hose 14100. Impermeable end cap 17100 also ensures that pressure is maintained throughout hose 14100 as water is being released from pressure barrel 18000. According to a further embodiment as shown in FIG. 15, a plurality of planters 2300 may be watered concurrently through a plurality of connectors secured to a plurality of emitters 12100. According to an even further embodiment, a subset of a plurality of planters 2300 may be selectively watered by fastening pressure barrel 18000 to hose 14100 where hose 14100 connects only to a subset of the plurality of planters 2300 secured to at least one panel 2200. This may be accomplished by using a plurality of hoses 14100 such that each of a plurality of panels 2300 is connected to a separate at least one hose 14100. This allows, for example, the watering of certain zones containing plants that require more water or zones that are close to a window and, accordingly, contain plants which require more water.

Various embodiments of the invention have been described in detail. Since changes in and or additions to the above-described best mode may be made without departing from the nature, spirit or scope of the invention, the invention is not to be limited to those details but only by the appended claims.

What is claimed is:

1. A plant wall, comprising:
a frame;
at least one panel, whereby the at least one panel is configured to secure to the frame and whereby the frame is configured to secure to a surface;
at least one planter, wherein the at least one planter is configured to secure to the at least one panel and the at least one planter is hollowed providing a means for containing a plant and soil;
at least one emitter, whereby the at least one emitter is positioned on the at least one planter and the at least one emitter defines a passage therethrough;
at least one hose, wherein the at least one hose has a first hose end, a second hose end, wherein the second hose end contains an impermeable end cap, and at least one connector to the at least one emitter positioned between the first hose end and the second hose end; and
a pressure barrel, wherein the pressure barrel is filled with water, and whereby the first hose end is configured to fasten to the pressure barrel and the at least one connector is secured to the at least one emitter, allowing for transportation of water from the pressure barrel through the at least one hose, through the passage defined by the at least one emitter, and into the at least one planter.

2. The plant wall of claim 1, wherein the frame is between 4.5 and 6.5 inches deep.

3. The plant wall of claim 1, wherein the frame is composed of wood.

4. The plant wall of claim 1, wherein a back face of the at least one panel is configured to secure to a front face of the frame and whereby a back face of the frame is configured to secure to a substantially vertical surface.

5. The plant wall of claim 1, wherein the at least one panel is a plurality of panels secured to the frame adjacent to one another.

6. The plant wall of claim 1, wherein the at least one panel is configured to secure to the frame by a French cleat system.

7. The plant wall of claim 1, wherein the at least one planter is a plurality of planters which are secured to the at least one panel adjacent to one another.

8. The plant wall of claim 1, wherein the soil is a combination of peat moss and perlite medium.

9. The plant wall of claim 1, wherein the plant is a tropical plant.

10. The plant wall of claim 1, wherein the at least one planter is composed of recycled polyethylene terephthalate and car tires.

11. The plant wall of claim 1, wherein the at least one planter contains at least one member, wherein the at least one member is a hooked lip that engages with a corrugated surface of a front face of the at least one panel.

12. The plant wall of claim 1, wherein the at least one emitter is positioned on the at least one planter proximate to roots of the plant.

13. The plant wall of claim 1, wherein the at least one connector is a plurality of connectors connected to an equal number of emitters.

14. The plant wall of claim 1, wherein the at least one hose is made from corrugated, non-kink material.

15. The plant wall of claim 1, wherein the first hose end contains a female portion that fastens to a male portion of the pressure barrel.

16. The plant wall of claim 1, wherein the pressure barrel is pressurized to five pounds per square inch.

17. The plant wall of claim 1, wherein the pressure barrel contains a mixture of water and plant nutrients.

18. The plant wall of claim 1, wherein the pressure barrel is portable.

19. A method of watering a plant, comprising:
fastening a pressure barrel, wherein the pressure barrel is filled with water, to a first end of a hose, wherein the hose further contains a second end with an impermeable end cap and at least one connector positioned between the first end of the hose and the second end of the hose; and
releasing the water contained in the pressure barrel, whereby the water flows through the hose to at least one emitter positioned on at least one planter, wherein the planter contains a plant and soil, and whereby the at least one emitter is secured to the at least one connector thereby allowing the water to flow therethrough.

20. The method of claim 19, wherein the method of watering a plant is applied to the plant wall of claim 1.

21. The method of claim 20, wherein a plurality of the at least one planter is watered concurrently through a plurality of the at least one connector secured to an equal number of emitters.

22. The method of claim 21, wherein a subset of the plurality of the at least one planter is selectively watered by fastening the hose to the subset of the plurality of the at least one planter.

23. The method of claim 20, wherein the at least one planter is secured to a vertical surface.

24. The method of claim 20, wherein the pressure barrel contains a mixture of water and plant nutrients.
